(19) United States
(12) Patent Application Publication
(10) Pub. No.: US 2024/0387952 A1
(43) Pub. Date: Nov. 21, 2024

(54) Busbar Assembly, Cylindrical Power Battery Module, and Battery Pack

(71) Applicant: EVE ENERGY CO., LTD., Huizhou (CN)

(72) Inventor: Shuai Yang, Huizhou (CN)

(21) Appl. No.: 18/372,671

(22) Filed: Sep. 25, 2023

(30) Foreign Application Priority Data
May 19, 2023 (CN) 202321230562.6

(51) Int. Cl. H01M 50/507; H01M 50/213; H01M 50/509; H01M 50/517

(52) U.S. Cl. CPC H01M 50/507; H01M 50/213; H01M 50/509; H01M 50/517

(57) ABSTRACT

Provided in the present application is a busbar assembly, including: a supporting frame, the supporting frame being provided with a restricting column, the restricting column being recessed with a recess in its own height direction; a busbar body, the busbar body being provided penetratingly with a through-hole in its own height direction, the restricting column penetrating the through-hole; a rivet buckle, the rivet buckle being in an interference fit with the recess, the busbar body being clamped between the rivet buckle and the supporting frame.

### CROSS-REFERENCE TO RELATED APPLICATIONS

The present application claims priority of Chinese Patent Application No. 2023212305626 filed on May 19, 2023 before CNIPA. All the above are hereby incorporated by reference in their entirety.

### FIELD

The present application relates to the field of batteries, in particular to a busbar assembly, a cylindrical power battery module, and a battery pack.

### BACKGROUND

Currently, the busbar in conventional large cylindrical power batteries is usually fixed by hot riveting process to fix the busbar. However, the hot riveted columns are only used once after planting and without the ability to be returned for repair. When a deformed or scratched busbar is detected on a finished CCS component and requires to be replaced, a single deformed or scratched busbar may usually damage the hot riveting column. The process of replanting the hot riveting column after replacement is cumbersome and improvements are available.

### SUMMARY

The present application aims to solve at least one of the technical problems of the prior art. Accordingly, an objective of the present application is to propose a busbar assembly, which effectively solves the problem of requiring renewal of the hot riveting columns when replacing the busbar body in the prior art, simplifies the process and improves the overall efficiency of the process.

Proposed in the present application is also a cylindrical power battery module, including the busbar assembly mentioned above.

Proposed in the present application is also a battery pack, including the cylindrical power battery module mentioned above.

As a first aspect, provided in an embodiment of the present application is a busbar as a first aspect, including:
a supporting frame, the supporting frame being provided with a restricting column, the restricting column being recessed inwardly with a recess;
a busbar body, the busbar body being penetratingly provided with a through-hole, the supporting frame being provided on the busbar body, the restricting column correspondingly penetrating the through-hole; and
a rivet buckle, the rivet buckle snapping into the recess, a side wall of the rivet buckle being in an interference fit with an interior side wall of the recess, the restricting column being clamped tightly between the side wall of the rivet buckle and the interior side wall of the recess.

In some implementations, the through-hole is provided as a fool-proofing hole, and the restricting column is provided as a fool-proofing column in an interference fit with the fool-proofing hole.

In some implementations, the fool-proofing hole includes a first hole segment and a second hole segment connected with each other, shapes of the first hole segment and the second hole segment being circular, a diameter of the first hole segment being smaller than that of the second hole segment; and
the fool-proofing column is in an interference fit with the first hole segment and the second hole segment.

In some implementations, the recess includes a first recess segment and a second recess segment connected with each other, shapes of the first recess segment and the second recess segment being circular, a diameter of the first recess segment being smaller than that of the second recess segment; and
the rivet buckle is in an interference fit with the first recess segment and the second recess segment.

In some implementations, a projection in a height direction of an extension part of the rivet buckle provided along a vertical outer side of the restricting column at least partially overlaps with the busbar body.

In some implementations, a height H1 of the busbar body is 0.4 mm≤H1≤0.5 mm, and a height H2 of the restricting column is 0.8 mm≤H2≤1 mm.

As a second aspect, provided in an embodiment of the present application is a cylindrical power battery module, including a busbar assembly mentioned above.

In some implementations, the cylindrical power battery module includes:
one or more cells;
an input plate, the input plate being connected to the single cell of an input terminal of the cylindrical power battery module;
an output plate, the output plate being connected to the single cell of an output terminal of the cylindrical power battery module,
in which the busbar body is provided between the input plate and the output plate, used for in a first direction cooperating the input plate and the output plate to connect two single cells provided in the first direction adjacently in series, used for in a second direction to connect two single cells provided in the second direction adjacently in parallel.

In some implementations, the busbar body includes one or more conductive units, and two adjacent conductive units are connected by a connecting part; and
the conductive unit includes a positive zone and a negative zone, the positive zone being used for abutting a positive end of the single cell, the negative zone being used for abutting a negative end of the single cell.

As a third aspect, provided in an embodiment of the present application is a battery pack, including a cylindrical power battery module mentioned above.

In summary, the present application provides technical effects as follows:

According to the present embodiment, by adopting an interference fit structure between the rivet buckle and the recess to mount the busbar body on the supporting frame, compared to a hot-riveting method adopted in the prior art, when the busbar assembly is detected to suffer from deformation or scratches and other defects of the busbar body to be replaced, the rivet buckle is removed from the recess to replace the new busbar body and then the rivet buckle is reassembled in the recess, which effectively solves the problem of requiring renewal of the hot riveting columns when replacing the busbar body in the prior art, and simplifies the process and improves the overall efficiency of the process.

### BRIEF DESCRIPTION OF THE DRAWINGS

FIG. 1 is a structural diagram of the busbar assembly in an embodiment of the present application;

FIG. 2 is another structural diagram of the busbar assembly in an embodiment of the present application;

FIG. 3 is a structural diagram of the busbar body of the busbar assembly in an embodiment of the present application;

FIG. 4 is a structural diagram of the rivet buckle of the busbar assembly in an embodiment of the present application;

FIG. 5 is a partially enlarged diagram of the restricting column and the recess of the busbar assembly in an embodiment of the present application.

Label: 1 supporting frame; 11 restricting column; 12 recess; 121 first recess segment; 122 second recess segment; 2 busbar body; 21 through-hole; 211 first hole segment; 212 second hole segment; 23 conductive unit; 231 positive zone; 232 negative zone; 3 rivet buckle; 31 first fool-proofing segment; 32 second fool-proofing segment; 33 extension part; 4 input plate; 5 output plate.

### DETAILED DESCRIPTION OF THE PREFERRED EMBODIMENTS

In the description of the present application, it is to be noted that, unless otherwise explicitly specified and limited, the terms “mounted”, “attached”, and “connected” should be broadly interpreted. For example, “attached” or “connected” to a mechanical structure may refer to a physical connection. For example, a physical connection may be a fixed connection, such as a fixed connection by a fixing member. For example, a fixed connection may be fixed by screws, bolts, or other fixing members; a physical connection may be a detachable connection, such as a mutual snap-fit connection. A physical connection may be an integral connection, such as a connection formed by welding, adhesive bonding, or integral molding. “Linked” or “connected” in the context of a circuit structure may refer not only to a physical connection, but also to an electrical connection or a signal connection, e.g., either directly, i.e., physically, or indirectly, through at least one intermediate element, as long as the circuit is connected. It may also be a connection within two elements; a signal connection may also refer to a signal connection through a media, e.g., radio waves, besides a signal connection through a circuit. For those skilled in the art, the specific meaning of the above terms in the context of an embodiment of the present application may be understood according to the specific situation.

In order to clearly describe the various orientations in the following embodiments, some terms of orientation may be used. For example, the expressions of the indicated directions used to illustrate the operation and the construction of the various members of the present embodiment, such as the direction X, the direction Y, and the direction Z described in the coordinate system, are not absolute but relative. Although these indications are appropriate when the various members are in the positions shown in the drawings, these directions should be interpreted differently to correspond to the changes when these positions are changed.

Based on the same understanding of orientation, in the description of the present application, the terms “center”, “longitudinal”, “transversal”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “peripheral” and other orientation or position relationships are based on the orientation or position relationships shown in the attached drawings. It is only intended to facilitate description and simplify operation, but not to indicate or imply that the referred device or element has a specific orientation, or is constructed and operated in a specific orientation. Therefore, they should not be construed as a limitation of the present application.

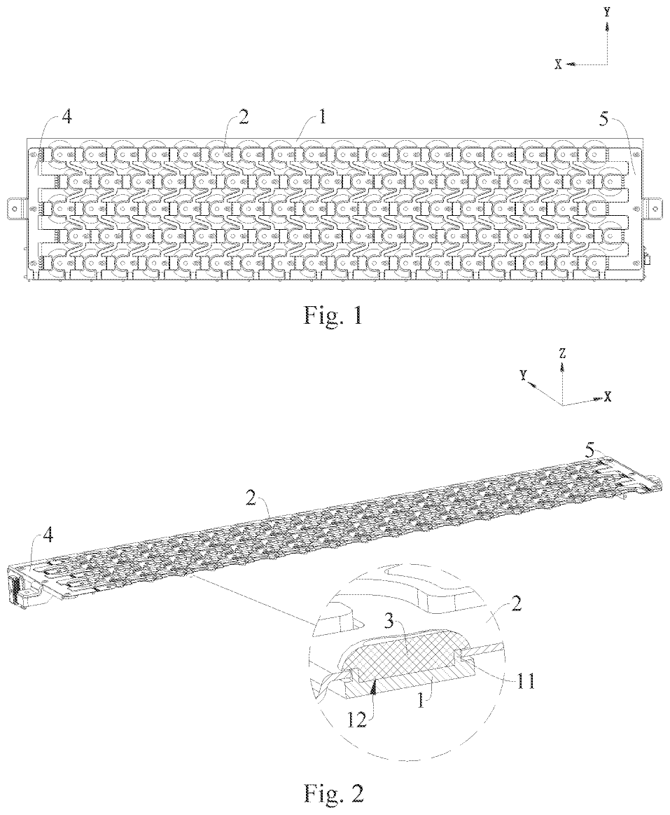

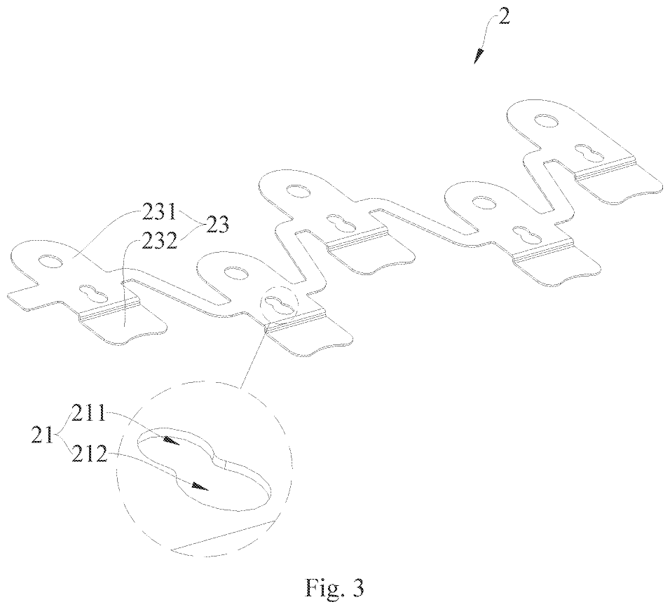

A busbar assembly, a cylindrical power battery module and a battery pack according to an embodiment of the present application are described below referring to FIG. 1-FIG. 5, and some embodiments of the present application are described in detail below in conjunction with the attached drawings. The following embodiments, as well as features in the embodiments, may be combined with each other in the absence of conflict.

In one embodiment, disclosed in an embodiment of the present application is a busbar assembly, applied to a cylindrical power battery module. The busbar assembly includes a supporting frame 1, a busbar body 2 and a rivet buckle 3. The supporting frame 1 is provided with a restricting column 11. The restricting column 11 is recessed inwardly with a recess 12. The busbar body 2 is penetratingly provided with a through-hole 21. The supporting frame 1 is provided on the busbar body 2. The restricting column 11 correspondingly penetrates the through-hole 21. The rivet buckle 3 snaps into the recess 12. A side wall of the rivet buckle 3 is in an interference fit with an interior side wall of the recess 12. The restricting column 11 is clamped tightly between the side wall of the rivet buckle 3 and the interior side wall of the recess 12. Optionally, the supporting frame 1 may specifically be a plastic supporting frame 1.

According to the present embodiment, a height direction is the Z direction shown in the figures. By adopting an interference fit structure between the rivet buckle 3 and the recess 12 to mount the busbar body 2 on the supporting frame 1, compared to a hot-riveting method adopted in the prior art, when the busbar assembly is detected to suffer from deformation or scratches and other defects of the busbar body 2 to be replaced, the rivet buckle 3 is removed from the recess 12 to replace the new busbar body 2 and then the rivet buckle 3 is reassembled in the recess 12, which effectively solves the problem of requiring renewal of the hot riveting columns when replacing the busbar body 2 in the prior art, and simplifies the process and improves the overall efficiency of the process.

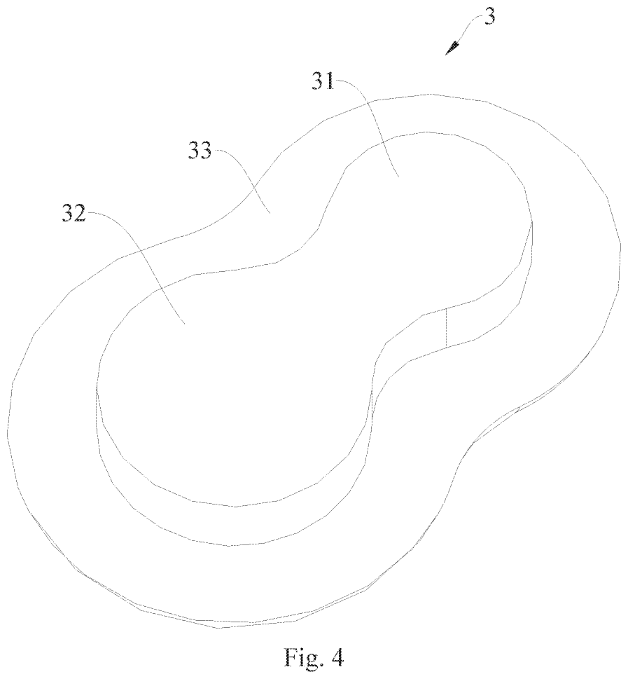

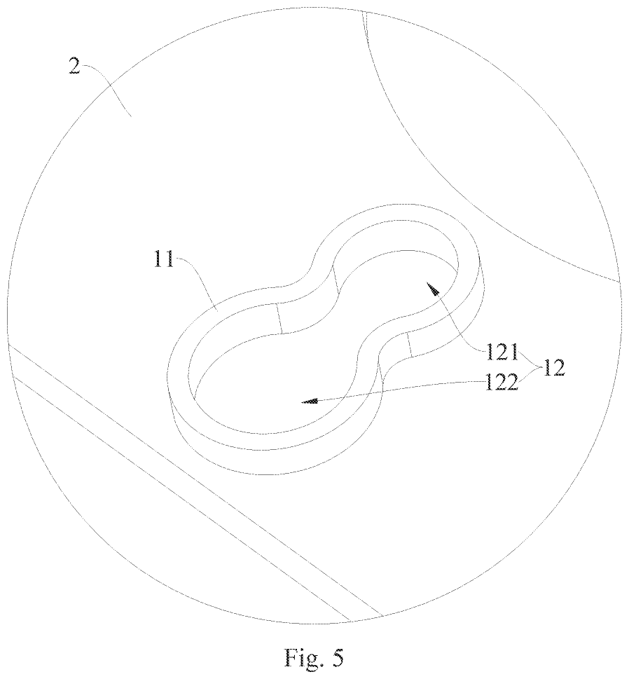

In one embodiment, referring to FIG. 4 and FIG. 5, the through-hole 21 is provided as a fool-proofing hole, and the restricting column 11 is provided as a fool-proofing column in an interference fit with the fool-proofing hole.

Further, referring to FIG. 5, the fool-proofing hole includes a first hole segment 211 and a second hole segment 212 connected with each other, shapes of the first hole segment 211 and the second hole segment 212 being circular, a diameter of the first hole segment 211 being smaller than that of the second hole segment 212; and the fool-proofing column is in an interference fit with the first hole segment 211 and the second hole segment 212.

According to the present embodiment, by providing a fool-proofing hole and a fool-proofing column, misaligned assembly between the busbar body 2 and the supporting frame 1 may be effectively avoided, thereby improving working efficiency. Optionally, the fool-proofing hole and the fool-proofing column may be shaped in a figure of eight or an hourglass to form an asymmetrical structure to achieve the fool-proofing effect.

Specifically, referring to FIG. 4, the fool-proofing column includes a first fool-proofing segment 31 and a second fool-proofing segment 32. Shapes of the first fool-proofing segment 31 and the second fool-proofing segment 32 are circular. A diameter of the first fool-proofing segment 31 is smaller than that of the second fool-proofing segment 32. An outer side wall of the first fool-proofing segment 31 is in an interference fit with an inner side wall of the first hole segment 211, and an outer side wall of the second fool-proofing segment 32 is in an interference fit with an inner side wall of the second hole segment 212, so as to form an asymmetrical structure to achieve the fool-proofing effect.

In one embodiment, referring to FIG. 5, the recess 12 includes a first recess segment 121 and a second recess segment 122 connected with each other, shapes of the first recess segment 121 and the second recess segment 122 being circular, a diameter of the first recess segment 121 being smaller than that of the second recess segment 122, and the rivet buckle 3 is in an interference fit with the first recess segment 121 and the second recess segment 122. Optionally, the recess 12 and the rivet buckle 3 may be shaped similarly to a figure of eight or an hourglass.

According to the present embodiment, since the restricting column 11 and the through-hole 21 are designed to be fool-proofing and their overall shape forms a figure of eight or an hourglass, shapes of the recess 12 and the rivet buckle 3 are improved in a compatible manner, which may effectively increase the contact area between the recess 12 and the rivet buckle 3 and increase the friction therebetween, so as to avoid detachment of the rivet buckle 3 from the recess 12 during use.

In one embodiment, referring to FIG. 1 to FIG. 4, a projection in a height direction of an extension part 33 of the rivet buckle 4 provided along a vertical outer side of the restricting column 11 at least partially overlaps with the busbar body 2. Optionally, the cross-section of the rivet buckle 3 is T-shaped.

According to the present embodiment, by providing a rivet buckle 3 with a T-shaped cross-section, the busbar body 2 may be restricted in a height direction, which prevents the busbar body 2 from detaching.

In one embodiment, in practice, taking into account various tolerances, a gap of 0.3 mm is usually provided between the busbar and the plastic supporting frame 1 to prevent the absence of a gap from leading to incomplete welding with the battery. However, the hot riveting process is easy to rivet completely, resulting in a direct adhesion between the busbar and the plastic supporting frame 1. There is no space for movement, which easily leads to incomplete welding. Therefore, a height H1 of the busbar body 2 is 0.4 mm≤H1≤0.5 mm, and a height H2 of the restricting column 11 is 0.8 mm≤H2≤1 mm. A gap of 0.3 mm may be effectively ensured to be provided between the busbar and the plastic supporting frame 1 to prevent from leading to the problem of incomplete welding.

The height H1 of the busbar body 2 is 0.4 mm≤H1≤0.5 mm. For example, the height H1 of the busbar body 2 may be such as 0.4 mm, 0.42 mm, 0.44 mm, 0.46 mm, 0.48 mm and 0.5 mm. Admittedly, in other embodiments, the height H1 of the busbar body 2 may be other values within the range.

The height H2 of the restricting column 11 is 0.8 mm≤H2≤1 mm. For example, the height H2 of the restricting column 11 may be such as 0.8 mm, 0.85 mm, 0.9 mm, 0.95 mm and 1 mm. Admittedly, in other embodiments, the height H2 of the restricting column 11 may be other values within the range.

Disclosed in the embodiment of the present application is also a cylindrical power battery module, the cylindrical power battery module includes the busbar assembly mentioned above.

In one embodiment, referring to FIG. 1 to FIG. 4, the cylindrical power battery module also includes an input plate 4, an output plate 5 and one or more single cells. The input plate 4 is connected to the single cell of an input terminal of the cylindrical power battery module, and the output plate 5 is connected to the single cell of the input terminal of the cylindrical power battery module, in which the busbar body 2 is provided between the input plate 4 and the output plate 5, used for in a first direction cooperating the input plate 4 and the output plate 5 to connect two single cells provided in the first direction adjacently in series, used for in a second direction to connect two single cells provided in the second direction adjacently in parallel. Specifically, a plurality of busbar bodies 2 is provided between the input plate 4 and the output plate 5, and a plurality of busbar bodies 2 is provided in an array in the first direction.

According to the present embodiment, the first direction is the direction X as shown in figures, and the second direction is the direction Y as shown in figures, in which one or more single cells constituting a cylindrical power battery module are arranged in an array in the first direction to form a battery unit of the cylindrical power battery module. The cylindrical power battery module in the present embodiment may include five battery units provided in parallel. Five battery units provided in parallel are stacked in the second direction, and two adjacent single cells of the battery unit are provided staggeredly in the first direction, so that more cylindrical single cells may be provided in an area of equal size.

A single cell connected to the input plate 4 is defined as a first cell and a single cell adjacent to the first cell in the first direction is a second cell. That is, in the first direction, each single cell of the battery unit is defined sequentially as a first cell, a second cell, until an N^{th} cell (N≥1, and N is a positive integer), i.e., N single cells are provided in an array in the first direction of a battery unit. When in use, the input plate 4 is connected to a positive end of the first cell, a first end of the busbar body 2 adjacent to the input plate 4 in the first direction is connected to a negative end of the first cell; and a second end of the busbar body 2 is connected to a positive end of the second cell. It is to be understood that an amount of the busbar body 2 between the input plate 4 and the output plate 5 in the first direction is N−1. For example, ten single cells are provided in an array in the first direction of a battery unit, so nine busbar bodies 2 are required to connect the ten single cells in series. Similarly, a first end of the N−1^{th} busbar body 2 is connected to a negative end of the N−1^{th} single cell; a second end of the N−1^{th} busbar body 2 is connected to a positive end of the N^{th} single cell; and the output plate 5 is connected to a negative end of the N^{th} single cell. Therefore, the connection of N single cells in series is achieved in the first direction by the input plate 4, the busbar body 2 and the output plate 5. Also, the five single cells of the battery unit stacked in the second direction are connected in parallel by the busbar body 2, so that the current of one or more of the five single cells of the battery unit stacked in the second direction may be balancedly distributed, which ensures the reliability of the connection between single cells.

In other embodiments, a cylindrical power battery module may be constituted by one or more battery units. When the cylindrical power battery module is constituted by a plurality of battery units, i.e., a plurality of battery units of the cylindrical power battery module is stacked in the second direction. Accordingly, the busbar body 2 may connect the plurality of battery units in parallel in the second direction. It is to be noted that both input plate 4 and output plate 5 are provided with a plurality of ends corresponding to a plurality of battery units, in which the ends are used for connecting to a positive end or a negative end of a single cell, so as to connect in the second direction the first or the last single cell of a plurality of battery units in the first direction in parallel.

Optionally, the input plate 4, output plate 5 and a plurality of busbar bodies are provided on the supporting frame 1.

In one embodiment, referring to FIG. 1 to FIG. 4, the busbar body 2 includes one or more conductive units 23, and two adjacent conductive units 23 are connected by a connecting part. The conductive unit 23 includes a positive zone 231 and a negative zone 232, the positive zone 231 being used for abutting a positive end of the single cell, the negative zone 232 being used for abutting a negative end of the single cell. In the present embodiment, the busbar body 2 includes five conductive units 23, and the five conductive units 23 correspond to five battery units. It is to be noted that the same conductive unit 23 abuts not the same single cell, but two adjacent ones. For facilitating description, two adjacent single cells are the first cell and the second cell respectively; i.e., the positive zone 231 of a conductive unit 23 abuts the positive end of the first cell; and the negative zone 232 of the conductive unit 23 abuts the negative end of the second sell.

Further, two adjacent conductive units 23 are provided staggeredly, so as to achieve that two adjacent single cells of the battery unit are provided staggeredly in the first direction, so that more cylindrical single cells may be provided in an area of equal size.

Disclosed in the embodiment of the present application is also a battery pack, the battery pack including the cylindrical power battery module mentioned above.

1. A busbar assembly, comprising:
a supporting frame, the supporting frame being provided with a restricting column, the restricting column being recessed inwardly with a recess;
a busbar body, the busbar body being penetratingly provided with a through-hole, the supporting frame being provided on the busbar body, the restricting column correspondingly penetrating the through-hole; and
a rivet buckle, the rivet buckle snapping into the recess, a side wall of the rivet buckle being in an interference fit with an interior side wall of the recess, the restricting column being clamped tightly between the side wall of the rivet buckle and the interior side wall of the recess.

2. The busbar assembly according to claim 1, wherein the through-hole is provided as a fool-proofing hole, and the restricting column is provided as a fool-proofing column in an interference fit with the fool-proofing hole.

3. The busbar assembly according to claim 2, wherein the fool-proofing hole comprises a first hole segment and a second hole segment connected with each other, shapes of the first hole segment and the second hole segment being circular, a diameter of the first hole segment being smaller than that of the second hole segment; and
the fool-proofing column is in an interference fit with the first hole segment and the second hole segment.

4. The busbar assembly according to claim 1, wherein the recess comprises a first recess segment and a second recess segment connected with each other, shapes of the first recess segment and the second recess segment being circular, a diameter of the first recess segment being smaller than that of the second recess segment; and
the rivet buckle is in an interference fit with the first recess segment and the second recess segment.

5. The busbar assembly according to claim 1, wherein a projection of an extension part of the rivet buckle provided along a vertical outer side of the restricting column at least partially overlaps with the busbar body in a height direction.

6. The busbar assembly according to claim 1, wherein a height H1 of the busbar body is 0.4 mm≤H1≤0.5 mm, and a height H2 of the restricting column is 0.8 mm≤H2≤1 mm.

7. A cylindrical power battery module, comprising a busbar assembly, the busbar assembly comprising:
a supporting frame, the supporting frame being provided with a restricting column, the restricting column being recessed inwardly with a recess;
a busbar body, the busbar body being penetratingly provided with a through-hole, the supporting frame being provided on the busbar body, the restricting column correspondingly penetrating the through-hole; and
a rivet buckle, the rivet buckle snapping into the recess, a side wall of the rivet buckle being in an interference fit with an interior side wall of the recess, the restricting column being clamped tightly between the side wall of the rivet buckle and the interior side wall of the recess.

8. The cylindrical power battery module according to claim 7, wherein the through-hole is provided as a fool-proofing hole, and the restricting column is provided as a fool-proofing column in an interference fit with the fool-proofing hole.

9. The cylindrical power battery module according to claim 8, wherein the fool-proofing hole comprises a first hole segment and a second hole segment connected with each other, shapes of the first hole segment and the second hole segment being circular, a diameter of the first hole segment being smaller than that of the second hole segment; and
the fool-proofing column is in an interference fit with the first hole segment and the second hole segment.

10. The cylindrical power battery module according to claim 7, wherein the recess comprises a first recess segment and a second recess segment connected with each other, shapes of the first recess segment and the second recess segment being circular, a diameter of the first recess segment being smaller than that of the second recess segment; and
the rivet buckle is in an interference fit with the first recess segment and the second recess segment.

11. The cylindrical power battery module according to claim 7, wherein a projection in a height direction of an extension part of the rivet buckle provided along a vertical outer side of the restricting column at least partially overlaps with the busbar body.

12. The cylindrical power battery module according to claim 7, wherein a height H1 of the busbar body is 0.4 mm≤H1≤0.5 mm, and a height H2 of the restricting column is 0.8 mm≤H2≤1 mm.

13. The cylindrical power battery module according to claim 7, comprising:
one or more single cells;
an input plate, the input plate being connected to the single cell of an input terminal of the cylindrical power battery module; and
an output plate, the output plate being connected to the single cell of an output terminal of the cylindrical power battery module,
wherein the busbar body is provided between the input plate and the output plate, used for in a first direction cooperating the input plate and the output plate to connect two single cells provided in the first direction adjacently in series, used for in a second direction to connect two single cells provided in the second direction adjacently in parallel.

14. The cylindrical power battery module according to claim 7, wherein the busbar body comprises one or more conductive units, and two adjacent conductive units are connected by a connecting part; and
the conductive unit comprises a positive zone and a negative zone, the positive zone being used for abutting a positive end of a single cell, the negative zone being used for abutting a negative end of the single cell.

15. A battery pack, comprising a cylindrical power battery module, the cylindrical power battery module comprising a busbar assembly, the busbar assembly comprising:
a supporting frame, the supporting frame being provided with a restricting column, the restricting column being recessed inwardly with a recess;
a busbar body, the busbar body being penetratingly provided with a through-hole, the supporting frame being provided on the busbar body, the restricting column correspondingly penetrating the through-hole; and
a rivet buckle, the rivet buckle snapping into the recess, a side wall of the rivet buckle being in an interference fit with an interior side wall of the recess, the restricting column being clamped tightly between the side wall of the rivet buckle and the interior side wall of the recess.

16. The battery pack according to claim 15, the cylindrical power battery module comprising:
one or more single cells;
an input plate, the input plate being connected to the single cell of an input terminal of the cylindrical power battery module; and
an output plate, the output plate being connected to the single cell of an output terminal of the cylindrical power battery module,
wherein the busbar body is provided between the input plate and the output plate, used for in a first direction cooperating the input plate and the output plate to connect two single cells provided in the first direction adjacently in series, used for in a second direction to connect two single cells provided in the second direction adjacently in parallel.

17. The battery pack according to claim 15, wherein the busbar body comprises one or more conductive units, and two adjacent conductive units are connected by a connecting part; and
the conductive unit comprises a positive zone and a negative zone, the positive zone being used for abutting a positive end of a single cell, the negative zone being used for abutting a negative end of the single cell.
